(19) United States
(12) Patent Application Publication
(10) Pub. No.: US 2026/0358913 A1
(43) Pub. Date: Nov. 12, 2026

(54) Touch knob applied to touch display panel

(71) Applicant: Raydium Semiconductor Corporation, Hsinchu (TW)

(72) Inventors: JUN-WEI LU, Hsinchu (TW); KUN-PEI LEE, Hsinchu (TW); JIA-YU YI, Hsinchu (TW); WEI-KUO LIU, Hsinchu (TW)

(21) Appl. No.: 19/287,905

(22) Filed: Aug. 1, 2025

(30) Foreign Application Priority Data
May 8, 2025 (TW) 114117326

(51) Int. Cl. G06F 3/0362; B60K 35/10; G06F 3/0354

(52) U.S. Cl. CPC G06F 3/0362; B60K 35/10; G06F 3/03547; B60K 2360/126; B60K 2360/1438; B60K 2360/1446; B60K 2360/145

(57) ABSTRACT

A touch knob applied to a touch display panel is disclosed. The touch knob includes an operating unit, a plurality of transmission units and a rotation unit. The operating unit is formed by conductors. The plurality of transmission units are formed by conductors. The rotation unit is configured to connect at least one transmission unit among the plurality of transmission units with the operating unit to generate at least one transmission signal. The operation mode of the touch knob is determined based on a reception condition of the at least one transmission signal.

### BACKGROUND OF THE INVENTION

### 1. Field of the Invention

The invention relates to touch; in particular, to a touch knob applied to a touch display panel.

### 2. Description of the Prior Art

In general, a display device with a touch knob used in the car can increase controllability, allowing users to more easily control the touch screen in the car by turning the knob.

However, as shown in FIG. 1A and FIG. 1B, the conventional touch knob KN is a metal pad movable knob, that is, the metal pad MP thereof moves as the touch knob KN rotates. The touch knob KN must be completely disposed within the active area AA of the touch display panel PL and cannot be partially disposed outside the active area AA, so the dust is easily accumulated thereon, resulting in signal reduction. In addition, as shown in FIG. 2, since the metal pad MP is disposed on the cover lens CL of the touch display panel PL, when the touch knob KN is rotated, the metal pad MP will move accordingly and may easily scratch the cover lens CL.

Therefore, the above problems encountered by the prior art still need to be further solved.

### SUMMARY OF THE INVENTION

Therefore, the invention provides a touch knob applied to a touch display panel to solve the above-mentioned problems of the prior arts.

A preferred embodiment of the invention is a touch knob applied to a touch display panel. In this embodiment, the touch knob includes an operating unit, a plurality of transmission units and a rotation unit. The operating unit is formed by conductors. The plurality of transmission units are formed by conductors. The rotation unit is configured to connect at least one transmission unit among the plurality of transmission units with the operating unit to generate at least one transmission signal. The operation mode of the touch knob is determined based on a reception condition of the at least one transmission signal.

In an embodiment, the plurality of transmission units include a first transmission unit, a second transmission unit and a third transmission unit; the first transmission unit is connected to the operating unit to generate a first transmission signal, the second transmission unit is connected to the operating unit to generate a second transmission signal, and the third transmission unit is connected to the operating unit to generate a third transmission signal; when the first transmission signal and the second transmission signal are received in sequence, or the second transmission signal and the third transmission signal are received in sequence, or the third transmission signal and the first transmission signal are received in sequence, the operation mode of the touch knob is determined as a first rotation direction mode.

In an embodiment, the plurality of transmission units include a first transmission unit, a second transmission unit and a third transmission unit; the first transmission unit is connected to the operating unit to generate a first transmission signal, the second transmission unit is connected to the operating unit to generate a second transmission signal, and the third transmission unit is connected to the operating unit to generate a third transmission signal; when the third transmission signal and the second transmission signal are received in sequence, or the second transmission signal and the first transmission signal are received in sequence, or the first transmission signal and the third transmission signal are received in sequence, the operation mode of the touch knob is determined as a second rotation direction mode.

In an embodiment, the plurality of transmission units include a first transmission unit, a second transmission unit and a third transmission unit; the first transmission unit is connected to the operating unit to generate a first transmission signal, the second transmission unit is connected to the operating unit to generate a second transmission signal, and the third transmission unit is connected to the operating unit to generate a third transmission signal; when only the first transmission signal, the second transmission signal or the third transmission signal is received, the operation mode of the touch knob is determined as a touch mode.

In an embodiment, the operating unit or the rotation unit is pressed, the plurality of transmission units are connected to the operating unit to generate a plurality of transmission signals; when the one or more transmission signals are received, the operation mode of the touch knob is determined as a pressing mode.

In an embodiment, the operating unit is connected to the plurality of transmission units in sequence.

In an embodiment, a plurality of connection times during which the plurality of transmission units are connected to the operating unit overlap with each other.

In an embodiment, a plurality of connection times during which the plurality of transmission units are connected to the operating unit do not overlap.

In an embodiment, a plurality of connection times during which the plurality of transmission units are connected to the operating unit partially overlap.

In an embodiment, the plurality of transmission units are disposed under a base of the touch knob and attached to the touch display panel.

In an embodiment, the touch knob is partially disposed outside an active area of the touch display panel.

In an embodiment, the operating unit is linked or unlinked with the rotation unit.

In an embodiment, the touch knob further includes a pressing transmission unit independent of the plurality of transmission units, wherein when the pressing transmission unit is pressed, the operating unit is connected to the pressing transmission unit separately to generate a pressing transmission signal; when the pressing transmission signal is received, the operation mode of the touch knob is determined as a pressing mode.

In an embodiment, the connection between the plurality of transmission units and the operating unit is triggered by pressing any position of the operating unit or the rotation unit.

In an embodiment, the connection between the pressing transmission unit and the operating unit is triggered by pressing any position of the operating unit or the rotation unit.

Compared to the prior art, the touch knob applied to the touch display panel proposed in the present invention can be partially disposed outside the active area of the touch display panel instead of being completely disposed within the active area of the touch display panel, which not only increases the flexibility in design, but also is less likely to accumulate dust and avoid signal reduction. In addition, since the transmission unit (the metal pad) does not move when the touch knob of the present invention is rotated, scratches on the cover glass of the touch display panel can be effectively avoided.

The advantage and spirit of the invention may be understood by the following detailed descriptions together with the appended drawings.

### BRIEF DESCRIPTION OF THE APPENDED DRAWINGS

FIG. 1A and FIG. 1B are schematic diagrams showing a conventional metal pad movable knob.

FIG. 2 is a cross-sectional view of a conventional metal pad movable knob.

FIG. 3A and FIG. 3B are schematic diagrams of a touch knob in a specific embodiment of the present invention; FIG. 3C is an exploded view of the touch knob in this specific embodiment.

FIG. 4A and FIG. 4B are timing diagrams of transmission signals in different operation

FIG. 5 is an embodiment of the corresponding relationship between the received transmission signal and the operation mode of the touch knob.

FIG. 6 is a schematic diagram showing another specific embodiment of the present invention in which the touch knob is further provided with a separate pressing transmission unit.

FIG. 7A to FIG. 7D are timing diagrams of transmission signals in different operation modes of the touch knob respectively.

FIG. 8A to FIG. 8G are schematic diagrams illustrating the actual assembly process steps of the components of the touch knob in FIG. 3C respectively.

FIG. 9 is a schematic diagram showing the internal circuit connections of a touch knob.

FIG. 10A and FIG. 10B are schematic diagrams of a first three-way switch that has not been pressed by a hand and a first three-way switch that has been pressed by a hand respectively.

FIG. 11A and FIG. 11B are schematic diagrams showing the internal structure of a sequential switch mechanism.

FIG. 12A is a schematic diagram showing a switch trigger seat disposed above the base for pressing a three-way switch to trigger it.

FIG. 12B is a schematic diagram showing that the first pin to the third pin of the sequential switch mechanism are electrically connected to the first transmission unit to the third transmission unit respectively.

FIG. 12C is a schematic diagram showing that the fourth pin of the sequential switch mechanism is electrically connected to the operating unit inside the touch knob.

FIG. 13 is a schematic diagram showing the internal circuit connections of the touch

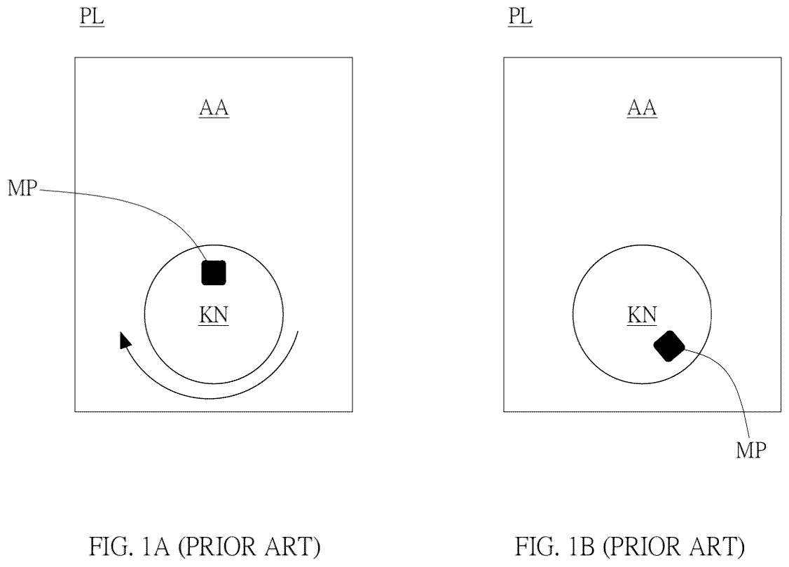

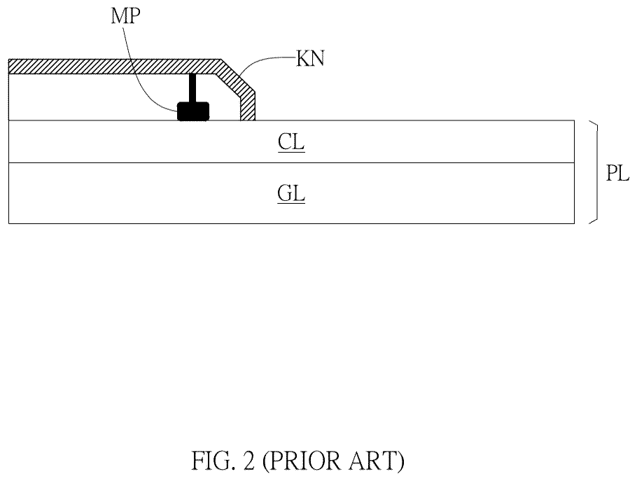

### DETAILED DESCRIPTION OF THE INVENTION

A preferred embodiment of the present invention is a touch knob. In fact, the touch knob can be applied to a touch display panel, and in particular to a car touch display screen, but is not limited to this.

It should be noted that the touch knob of the present invention can be partially disposed outside the active area of the touch display panel. When the user rotates the touch knob, the operating unit composed of a conductor will be connected to at least one immovable transmission unit (such as a metal pad) to generate at least one transmission signal, and then the operation mode of the touch knob is determined according to the receiving condition of the at least one transmission signal, such as a forward rotation mode, a reverse rotation mode, a touch mode, a pressing mode, etc.

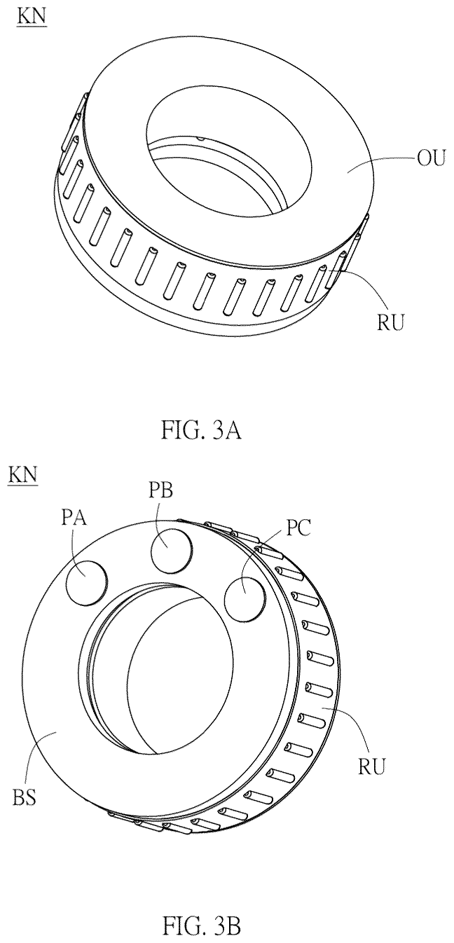

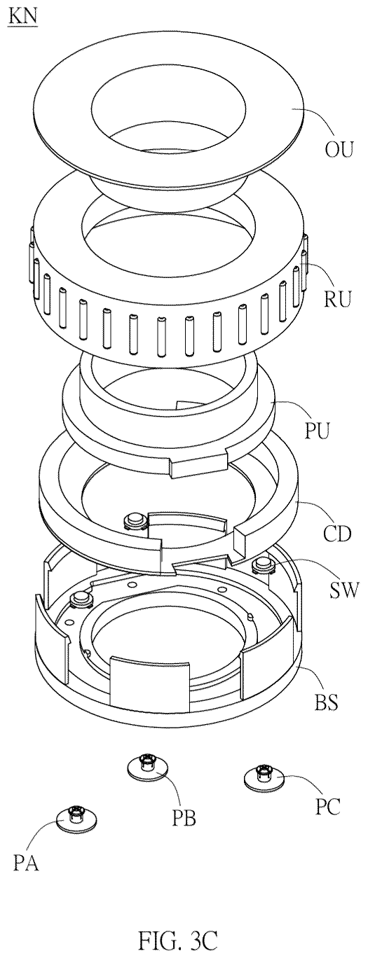

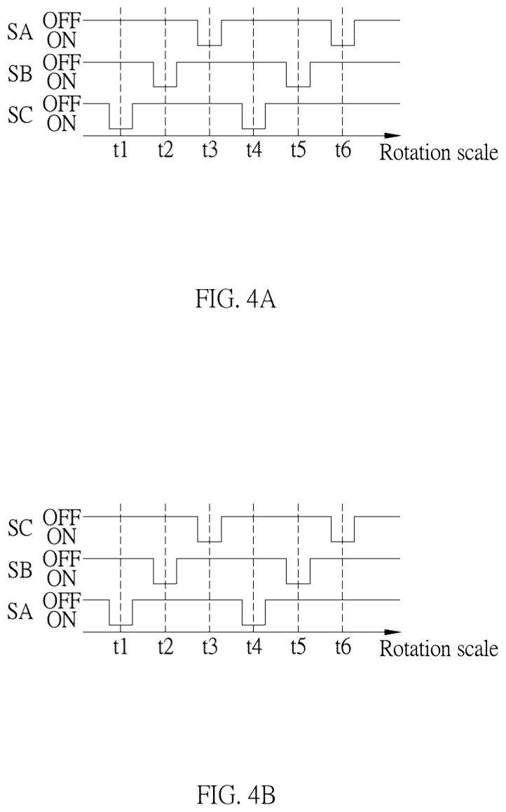

As shown in FIG. 3A and FIG. 3B, the touch knob KN includes a plurality of transmission units PA to PC (e.g., metal pads) formed of conductors and an operating unit OU formed of conductors. The plurality of transmission units PA to PC include a first transmission unit PA, a second transmission unit PB and a third transmission unit PC. The first transmission unit PA, the second transmission unit PB and the third transmission unit PC are respectively disposed below the touch knob KN at intervals and the first transmission unit PA, the second transmission unit PB and the third transmission unit PC will not move. A rotation unit RU of the touch knob KN is configured to enable the operating unit OU to be connected to at least one of the immovable first transmission unit PA, the second transmission unit PB and the third transmission unit PC to generate at least one transmission signal (for example, the first transmission signal SA, the second transmission signal SB and the third transmission signal SC shown in FIG. 4A and FIG. 4B), and then determine the operation mode of the touch knob KN based on the receiving condition of the at least one transmission signal.

It should be noted that the operating unit OU (for example, a conductive object) can be linked or not linked to the rotation unit RU (for example, a turntable); the operating unit OU can be connected to the first transmission unit PA, the second transmission unit PB and the third transmission unit PC in sequence; the connection between the operating unit OU and the first transmission unit PA, the second transmission unit PB and the third transmission unit PC can be triggered by pressing any position of the operating unit OU or the rotation unit RU; the connection time of the first transmission unit PA, the second transmission unit PB and the third transmission unit PC with the operating unit OU can overlap with each other, partially overlap or not overlap at all.

For example, assume that the first transmission unit PA can be connected to the operating unit OU to generate a first transmission signal SA, the second transmission unit PB can be connected to the operating unit OU to generate a second transmission signal SB, and the third transmission unit PC can be connected to the operating unit OU to generate a third transmission signal SC.

When the first transmission signal SA and the second transmission signal SB are received in sequence, or the second transmission signal SB and the third transmission signal SC are received in sequence, or the third transmission signal SC and the first transmission signal SA are received in sequence, that is, the operating unit OU is first connected to the first transmission unit PA and then connected to the second transmission unit PB, or the operating unit OU is first connected to the second transmission unit PB and then connected to the third transmission unit PC, or the operating unit OU is first connected to the third transmission unit PC and then connected to the first transmission unit PA, the operation mode of the touch knob KN will be determined as a first rotation direction mode (for example, a reverse rotation mode).

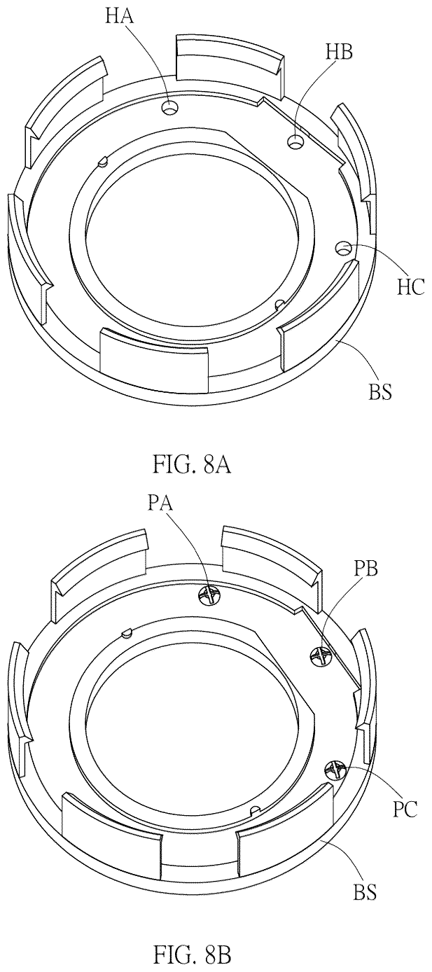

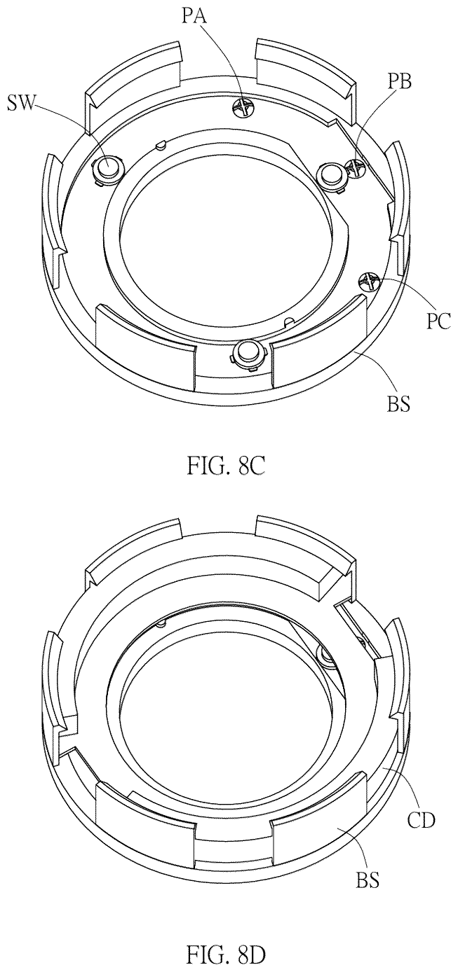

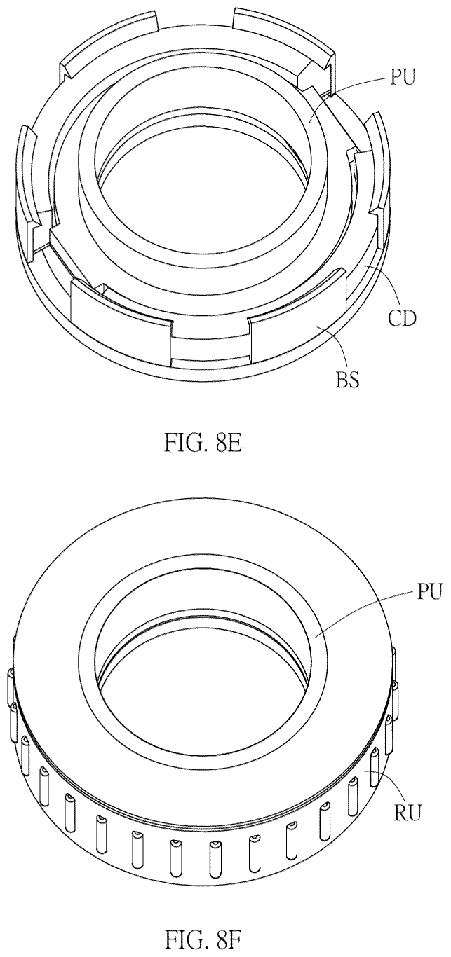

When the third transmission signal SC and the second transmission signal SB are received in sequence, or the second transmission signal SB and the first transmission signal SA are received in sequence, or the first transmission signal SA and the third transmission signal SC are received in sequence, that is, the operating unit OU is first connected to the third transmission unit PC and then connected to the second transmission unit PB, or the operating unit OU is first connected to the second transmission unit PB and then connected to the first transmission unit PA, or the operating unit OU is first connected to the first transmission unit PA and then connected to the third transmission unit PC, the operation mode of the touch knob KN will be determined as a second rotation direction mode (for example, a forward rotation mode). Next, please refer to FIG. 3C, which is an exploded view of the touch knob KN in this specific embodiment. As shown in FIG. 3C, the touch knob KN can include, from bottom to top, a first transmission unit PA to a third transmission unit PC, a base BS, a three-way switch SW, a switch trigger seat CD, a sequential switch mechanism PU, a rotation unit RU and an operating unit OU. The base BS of the touch knob KN is attached to the touch display panel, and the first transmission unit PA to the third transmission unit PC are disposed on the base BS at intervals. The actual assembly process steps of the components of the touch knob KN will be described in detail in the following FIG. 8A to FIG. 8G.

As shown in FIG. 4A, the receiving condition of the first transmission signal SA, the second transmission signal SB and the third transmission signal SC is that the third transmission signal SC, the second transmission signal SB, the first transmission signal SA, the third transmission signal SC, the second transmission signal SB, and the first transmission signal SA are received in sequence during the rotation scales t1~t6, indicating that during the rotation scales t1~t6, the operation mode of the touch knob KN is the second rotation direction mode (for example, the forward rotation mode).

As shown in FIG. 4B, the receiving condition of the first transmission signal SA, the second transmission signal SB and the third transmission signal SC is that the first transmission signal SA, the second transmission signal SB, the third transmission signal SC, the first transmission signal SA, the second transmission signal SB, and the third transmission signal SC are received in sequence during the rotation scales t1~t6, indicating that during the rotation scales t1~t6, the operation mode of the touch knob KN is the first rotation direction mode (for example, the reverse rotation mode).

In addition, when only the first transmission signal SA, the second transmission signal SB or the third transmission signal SC is received, it means that the received transmission signal has not changed, and the operation mode of the touch knob KN is determined as a touch mode. When the operating unit OU or the rotation unit RU is pressed, the first transmission unit PA, the second transmission unit PB and the third transmission unit PC are connected to the operating unit OU to generate the first transmission signal SA, the second transmission signal SB and the third transmission signal SC. When two or more transmission signals (for example, the first transmission signal SA, the second transmission signal SB and the third transmission signal SC) are received at the same time, the operation mode of the touch knob KN will be determined as a pressing mode.

It should be noted that the connection time of the first transmission unit PA, the second transmission unit PB and the third transmission unit PC connected with the operating unit OU can overlap, partially overlap or not overlap with each other, and there is no specific limitation.

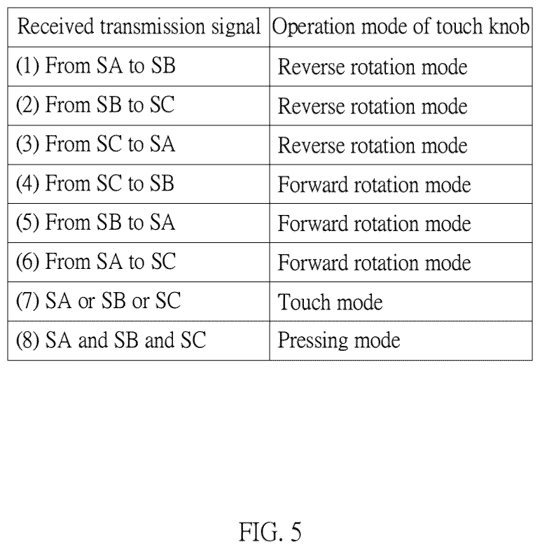

Please refer to FIG. 5. The corresponding relationship between the received transmission signal and the operation mode of the touch knob KN includes but not limited to the following items: (1) when the received transmission signal changes from the first transmission signal SA to the second transmission signal SB, the operation mode of the touch knob KN is determined as the reverse rotation mode; (2) when the received transmission signal changes from the second transmission signal SB to the third transmission signal SC, the operation mode of the touch knob KN is determined as the reverse rotation mode; (3) when the received transmission signal changes from the third transmission signal SC to the first transmission signal SA, the operation mode of the touch knob KN is determined as the reverse rotation mode; (4) when the received transmission signal changes from the third transmission signal SC to the second transmission signal SB, the operation mode of the touch knob KN is determined as the forward rotation mode; (5) when the received transmission signal changes from the second transmission signal SB to the first transmission signal SA, the operation mode of the touch knob KN is determined as the forward rotation mode; (6) when the received transmission signal changes from the first transmission signal SA to the third transmission signal SC, the operation mode of the touch knob KN is determined as the forward rotation mode; (7) when the received transmission signal only includes the first transmission signal SA, the second transmission signal SB or the third transmission signal SC, the operation mode of the touch knob KN is determined as the touch mode; (8) when the received transmission signal includes the first transmission signal SA, the second transmission signal SB and the third transmission signal SC at the same time, the operation mode of the touch knob KN is determined as the pressing mode, but not limited to this.

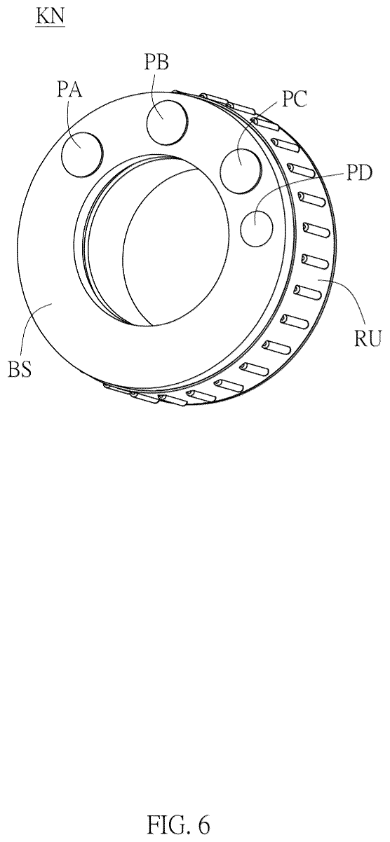

In another embodiment, as shown in FIG. 6, the first transmission unit PA, the second transmission unit PB, the third transmission unit PC and the separate pressing transmission unit PD are respectively disposed at intervals on the base BS located below the touch knob KN, and the first transmission unit PA, the second transmission unit PB, the third transmission unit PC and the separate pressing transmission unit PD will not move. Assume that the first transmission unit PA can be connected to the operating unit OU to generate a first transmission signal SA, the second transmission unit PB can be connected to the operating unit OU to generate a second transmission signal SB, the third transmission unit PC can be connected to the operating unit OU to generate a third transmission signal SC, and a separate pressing transmission unit PD can be connected to the operating unit OU to generate a fourth transmission signal SD.

When the first transmission signal SA and the second transmission signal SB are received in sequence, or the second transmission signal SB and the third transmission signal SC are received in sequence, or the third transmission signal SC and the fourth transmission signal SA are received in sequence, that is, the operating unit OU is first connected to the first transmission unit PA and then connected to the second transmission unit PB, or the operating unit OU is first connected to the second transmission unit PB and then connected to the third transmission unit PC, or the operating unit OU is first connected to the third transmission unit PC and then connected to the first transmission unit PA, the operation mode of the touch knob KN will be determined as the first rotation direction mode (for example, the reverse rotation mode).

When the third transmission signal SC and the second transmission signal SB are received in sequence, or the second transmission signal SB and the first transmission signal SA are received in sequence, or the first transmission signal SA and the fourth transmission signal SC are received in sequence, that is, the operating unit OU is first connected to the third transmission unit PC and then connected to the second transmission unit PB, or the operating unit OU is first connected to the second transmission unit PB and then connected to the first transmission unit PA, or the operating unit OU is first connected to the first transmission unit PA and then connected to the third transmission unit PC, the operation mode of the touch knob KN will be determined as the second rotation direction mode (for example, the forward rotation mode).

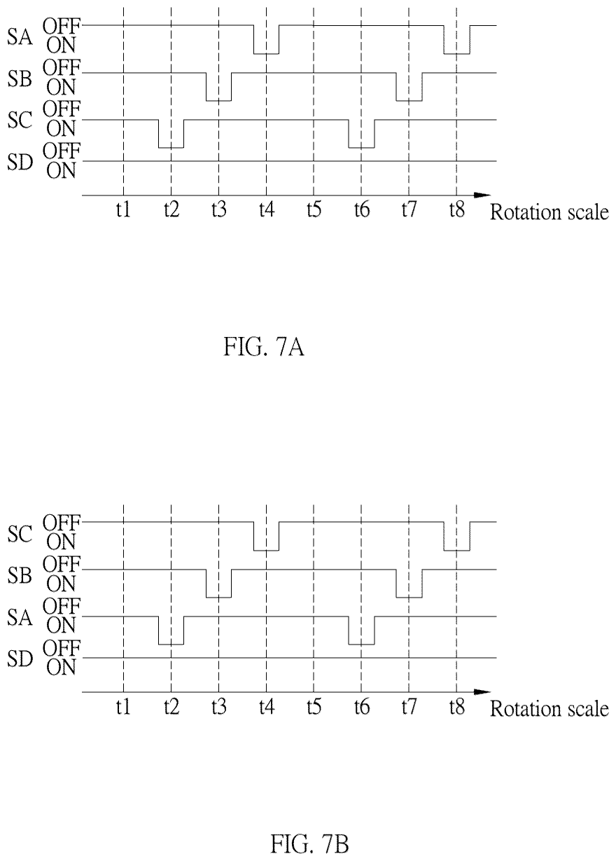

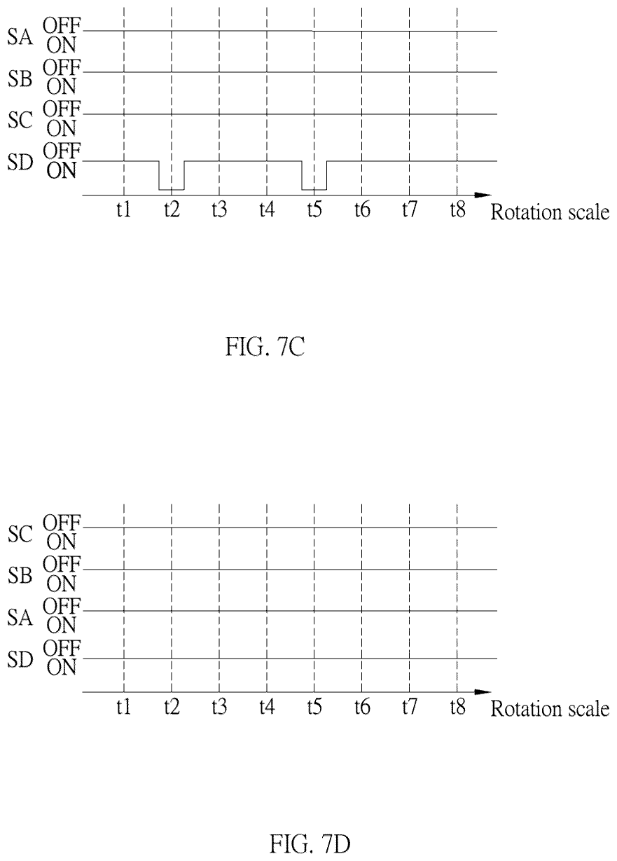

As shown in FIG. 7A, the receiving condition of the first transmission signal SA, the second transmission signal SB, and the third transmission signal SC is that the third transmission signal SC, the second transmission signal SB, the first transmission signal SA, the third transmission signal SC, the second transmission signal SB, and the first transmission signal SA are received in sequence during the rotation scales t1~t8, indicating that during the period of the rotation scales t1~t8, the operation mode of the touch knob KN will be determined as the second rotation direction mode (for example, the forward rotation mode).

As shown in FIG. 7B, the receiving conditions of the first transmission signal SA, the second transmission signal SB, and the third transmission signal SC are as follows: the first transmission signal SA, the second transmission signal SB, the third transmission signal SC, the first transmission signal SA, the second transmission signal SB, and the third transmission signal SC are received in sequence during the rotation scales t1~t8, indicating that during the period of the rotation scales t1~t8, the operation mode of the touch knob KN will be determined as the first rotation direction mode (for example, the reverse rotation mode).

As shown in FIG. 7C, when the operating unit OU or the rotation unit RU is pressed, the separate pressing transmission unit PD is connected to the operating unit OU to generate a fourth transmission signal SD, and the operation mode of the touch knob KN will be determined as the pressing mode. As shown in FIG. 7D, when the operating unit OU and the rotation unit RU are not pressed, the separate pressing transmission unit PD will not be connected to the operating unit OU and will not generate the fourth transmission signal SD, and the operation mode of the touch knob KN will be determined as a non-pressing mode. In addition, when only the first transmission signal SA, the second transmission signal SB or the third transmission signal SC is received, the operation mode of the touch knob KN will be determined as the touch mode.

It should be noted that the connection time between the first transmission unit PA, the second transmission unit PB, the third transmission unit PC and the separate pressing transmission unit PD and the operating unit OU may overlap, partially overlap or not overlap with each other, and there is no specific limitations.

Next, please refer to FIG. 8A to FIG. 8G, which are schematic diagrams illustrating the actual assembly process steps of the components of the touch knob KN in FIG. 3C respectively.

In the first step, as shown in FIG. 8A, a first hole HA to a third hole HC are disposed at intervals on the base BS of the touch knob KN.

In the second step, as shown in FIG. 8B, the first transmission unit PA to the third transmission unit PC are respectively passed through the first hole HA to the third hole HC from below the base BS, so that the first transmission unit PA to the third transmission unit PC are spaced apart and disposed below the base BS.

In the third step, as shown in FIG. 8C, the three three-way switches SW are spaced apart on the base BS and each three-way switch SW is electrically connected to the first transmission unit PA to the third transmission unit PC, so that any position of the touch knob KN can be pressed.

In the fourth step, as shown in FIG. 8D, the switch trigger seat CD is disposed above the base BS and located above the three three-way switches SW and the first transmission unit PA to the third transmission unit PC to selectively trigger the three-way switches SW. In the fifth step, as shown in FIG. 8E, the sequential switch mechanism PU is disposed in the recessed area in the middle of the switch trigger seat CD.

In the sixth step, as shown in FIG. 8F, the rotation unit RU (e.g., a turntable) is placed outside the base BS and the sequential switch mechanism PU, and the upper surface of the rotation unit RU is aligned with the upper surface of the sequential switch mechanism PU.

In the seventh step, as shown in FIG. 8G, the operating unit OU (e.g., a conductive object) is finally disposed above the upper surfaces of the rotation unit RU and the sequential switch mechanism PU so that the user can press the operating unit OU.

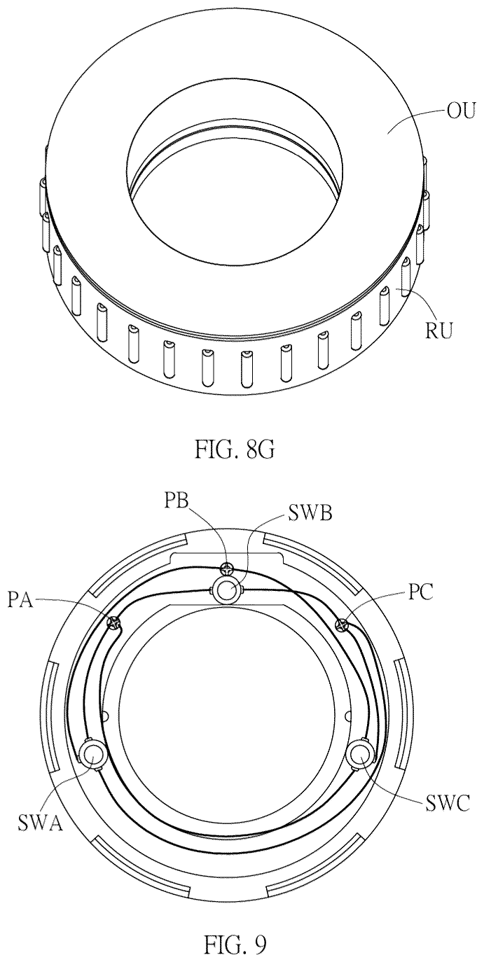

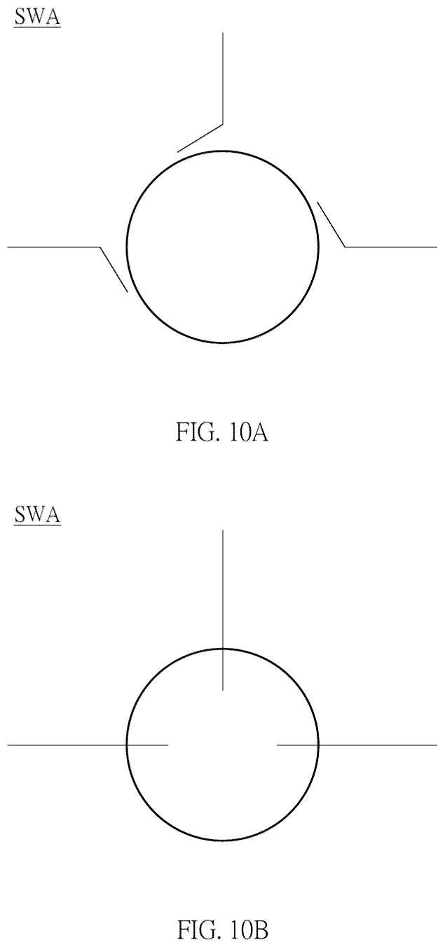

It should be noted that, as shown in FIG. 9, the three pins of the first three-way switch SWA need to be electrically connected to the first transmission unit PA to the third transmission unit PC, the three pins of the second three-way switch SWB also need to be electrically connected to the first transmission unit PA to the third transmission unit PC, and the three pins of the third three-way switch SWC also need to be electrically connected to the first transmission unit PA to the third transmission unit PC, so that any position of the touch knob KN can be pressed. In addition, FIG. 10A and FIG. 10B are schematic diagrams of the first three-way switch SWA that has not been pressed by the hand and the first three-way switch SWA that has been pressed by the hand respectively.

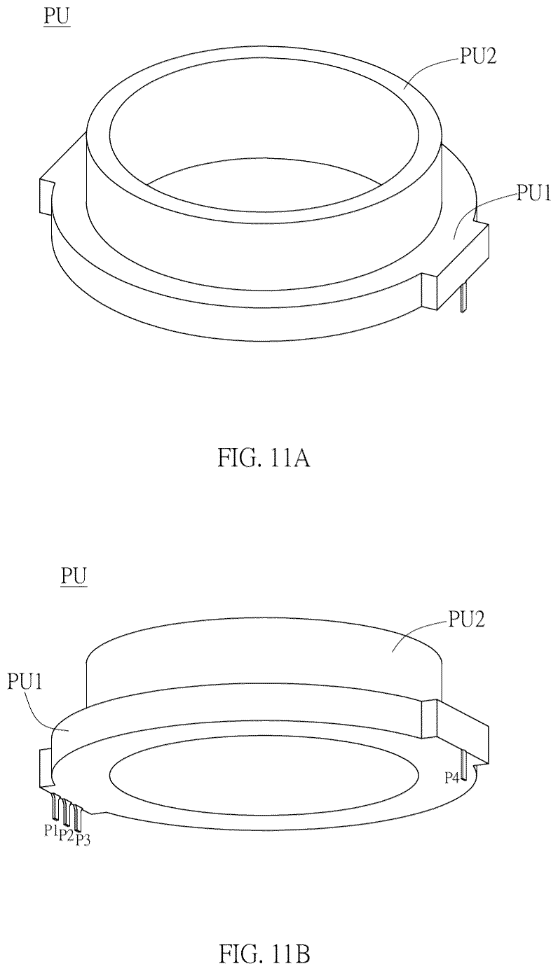

In one embodiment, as shown in FIG. 11A and FIG. 11B, the sequential switch mechanism PU includes a first component PU1 and a second component PU2, and the second component PU2 is disposed above the first component PU1. When the second component PU2 rotates, the fourth pin P4 will be electrically connected to the first pin P1 to the third pin P3 in sequence and conduct.

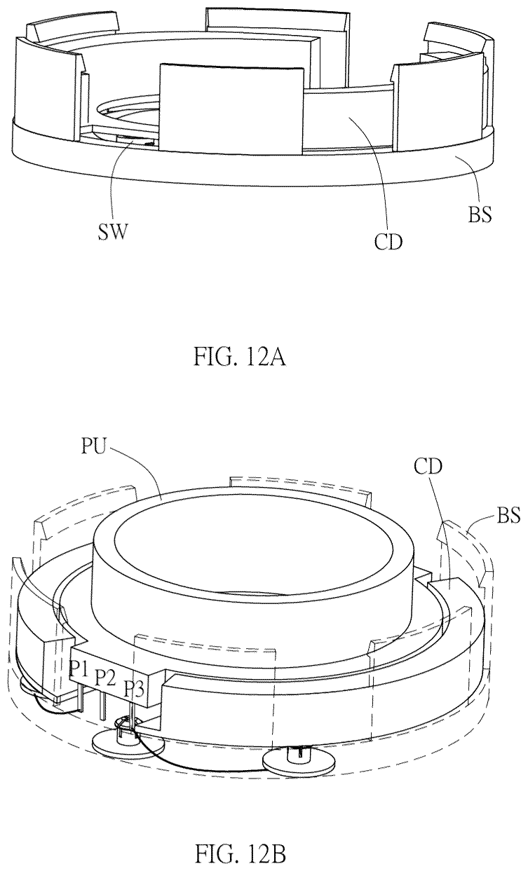

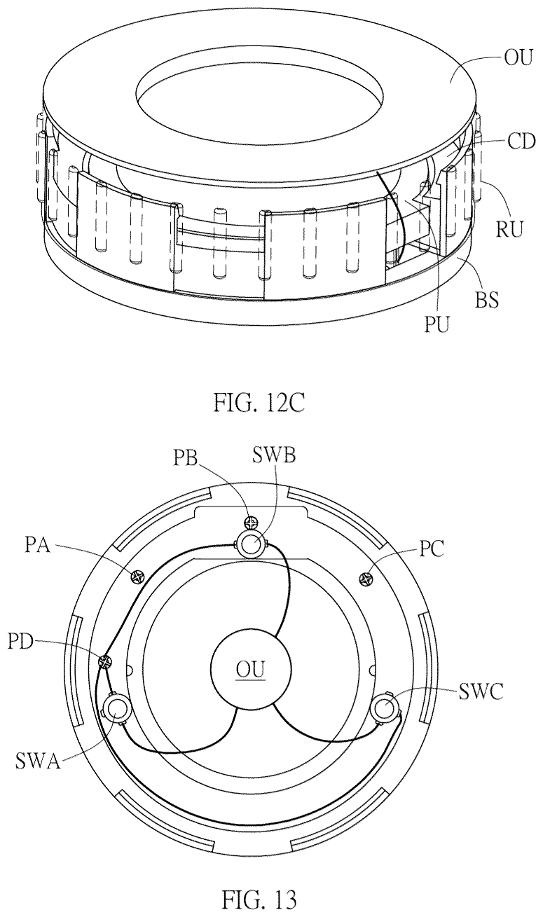

In one embodiment, as shown in FIG. 12A, a switch trigger seat CD disposed above the base BS is configured to press the three-way switch SW to trigger it.

In one embodiment, as shown in FIG. 12B, the first pin P1 to the third pin P3 of the sequential switch mechanism PU should be electrically connected to the first transmission unit PA to the third transmission unit PC respectively.

In one embodiment, as shown in FIG. 12C, the fourth pin P4 of the sequential switch mechanism PU should be electrically connected to the operating unit OU inside the touch knob KN.

In one embodiment, please refer to FIG. 13, which is a schematic diagram showing the internal circuit connections of the touch knob KN in FIG. 6 that is provided with a separate pressing transmission unit PD. As shown in FIG. 13, the pressing transmission unit PD is independently disposed outside the first transmission unit PA, the second transmission unit PB, and the third transmission unit PC. One pin of the first three-way switch SWA needs to be electrically connected to the separate pressing transmission unit PD and the other pin thereof needs to be electrically connected to the operating unit OU, one pin of the second three-way switch SWB needs to be electrically connected to the separate pressing transmission unit PD and the other pin thereof needs to be electrically connected to the operating unit OU, and one pin of the third three-way switch SWC needs to be electrically connected to the separate pressing transmission unit PD and the other pin thereof needs to be electrically connected to the operating unit OU. When the operating unit OU is pressed, the operating unit OU is independently connected to the pressing transmission unit PD. When a pressing transmission signal generated by the pressing transmission unit PD is received, the operation mode of the touch knob KN will be determined as the pressing mode.

Compared to the prior art, the touch knob applied to the touch display panel proposed in the present invention can be partially disposed outside the active area of the touch display panel instead of being completely disposed within the active area of the touch display panel, which not only increases the flexibility in design, but also is less likely to accumulate dust and avoid signal reduction. In addition, since the transmission unit (metal pad) does not move when the touch knob of the present invention is rotated, scratches on the cover glass of the touch display panel can be effectively avoided.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A touch knob, applied to a touch display panel, comprising:
an operating unit formed by conductors;
a plurality of transmission units formed by conductors;
a sequential switch mechanism, comprising a plurality of pins electrically connected with the plurality of transmission units and another pin electrically connected with the operating unit; and
a rotation unit, placed outside the sequential switch mechanism, when the sequential switch mechanism rotates with the rotation unit, the another pin being electrically connected to the plurality of pins in sequence and conduct to connect at least one transmission unit among the plurality of transmission units with the operating unit to generate at least one transmission signal;
wherein an operation mode of the touch knob is determined based on a reception condition of the at least one transmission signal.

2. The touch knob of claim 1, wherein the plurality of transmission units comprise a first transmission unit, a second transmission unit and a third transmission unit; the first transmission unit is connected to the operating unit to generate a first transmission signal, the second transmission unit is connected to the operating unit to generate a second transmission signal, and the third transmission unit is connected to the operating unit to generate a third transmission signal; when the first transmission signal and the second transmission signal are received in sequence, or the second transmission signal and the third transmission signal are received in sequence, or the third transmission signal and the first transmission signal are received in sequence, the operation mode of the touch knob is determined as a first rotation direction mode.

3. The touch knob of claim 1, wherein the plurality of transmission units comprise a first transmission unit, a second transmission unit and a third transmission unit; the first transmission unit is connected to the operating unit to generate a first transmission signal, the second transmission unit is connected to the operating unit to generate a second transmission signal, and the third transmission unit is connected to the operating unit to generate a third transmission signal; when the third transmission signal and the second transmission signal are received in sequence, or the second transmission signal and the first transmission signal are received in sequence, or the first transmission signal and the third transmission signal are received in sequence, the operation mode of the touch knob is determined as a second rotation direction mode.

4. The touch knob of claim 1, wherein the plurality of transmission units comprise a first transmission unit, a second transmission unit and a third transmission unit; the first transmission unit is connected to the operating unit to generate a first transmission signal, the second transmission unit is connected to the operating unit to generate a second transmission signal, and the third transmission unit is connected to the operating unit to generate a third transmission signal; when only the first transmission signal, the second transmission signal or the third transmission signal is received, the operation mode of the touch knob is determined as a touch mode.

5. The touch knob of claim 1, wherein when the operating unit or the rotation unit is pressed, the plurality of transmission units are connected to the operating unit to generate a plurality of transmission signals; when the one or more transmission signals are received, the operation mode of the touch knob is determined as a pressing mode.

6. The touch knob of claim 1, wherein the operating unit is connected to the plurality of transmission units in sequence.

7. The touch knob of claim 1, wherein a plurality of connection times during which the plurality of transmission units are connected to the operating unit overlap with each other.

8. The touch knob of claim 1, wherein a plurality of connection times during which the plurality of transmission units are connected to the operating unit do not overlap.

9. The touch knob of claim 1, wherein a plurality of connection times during which the plurality of transmission units are connected to the operating unit partially overlap.

10. The touch knob of claim 1, wherein the plurality of transmission units are disposed under a base of the touch knob and attached to the touch display panel.

11. The touch knob of claim 1, wherein the touch knob is partially disposed outside an active area of the touch display panel.

12. The touch knob of claim 1, wherein the operating unit is linked or unlinked with the rotation unit.

13. The touch knob of claim 1, further comprising a pressing transmission unit independent of the plurality of transmission units, wherein when the pressing transmission unit is pressed, the operating unit is connected to the pressing transmission unit separately to generate a pressing transmission signal; when the pressing transmission signal is received, the operation mode of the touch knob is determined as a pressing mode.

14. The touch knob of claim 5, wherein the connection between the plurality of transmission units and the operating unit is triggered by pressing any position of the operating unit or the rotation unit.

15. The touch knob of claim 13, wherein the connection between the pressing transmission unit and the operating unit is triggered by pressing any position of the operating unit or the rotation unit.
